(19) United States
(12) Patent Application Publication
(10) Pub. No.: US 2014/0194147 A1
(43) Pub. Date: Jul. 10, 2014

(54) APPARATUS AND METHOD FOR REDUCING BATTERY CONSUMPTION OF MOBILE TERMINAL

(71) Applicant: Samsung Electronics Co., Ltd., Suwon-si (KR)

(72) Inventors: Jeong-Gwan KANG, Hwaseong-si (KR); Nam-Hoon KIM, Suwon-si (KR); Kyong-Ha PARK, Suwon-si (KR); Sung-Min PARK, Seoul (KR); Hyun-Su HONG, Seongnam-si (KR)

(73) Assignee: Samsung Electronics Co., Ltd., Suwon-si (KR)

(21) Appl. No.: 14/149,201

(22) Filed: Jan. 7, 2014

(30) Foreign Application Priority Data
Jan. 8, 2013 (KR) 10-2013-0002125

(51) Int. Cl. H04W 4/02; H04W 52/02

(52) U.S. Cl. CPC H04W 4/023; H04W 52/0274
USPC 455/456.3; 455/566

(57) ABSTRACT

An apparatus and a method for reducing battery consumption of a mobile terminal are provided. The method includes calculating a current location of the mobile terminal, route information to a destination, and an alarm period for determining whether the mobile terminal has arrived at the destination or at a nearby region of the destination, if the destination is input, and deactivating a locating module before the alarm period has elapsed, determining whether the mobile terminal has arrived at the destination or the nearby region of the destination if the alarm period has elapsed, and notifying the user that the mobile terminal has arrived at the destination or the nearby region of the destination if the mobile terminal has arrived at the destination or the nearby region of the destination.

### CROSS-REFERENCE TO RELATED APPLICATION(S)

This application claims the benefit under 35 U.S.C. §119(a) of a Korean patent application filed on Jan. 8, 2013 in the Korean Intellectual Property Office and assigned Serial number 10-2013-0002125, the entire disclosure of which is hereby incorporated by reference.

### TECHNICAL FIELD

The present disclosure relates to a mobile terminal. More particularly, the present disclosure relates to an apparatus and method for reducing battery consumption of a mobile terminal

### BACKGROUND

A mobile terminal may upload or download various programs or applications to or from a server through wired/wireless communication, which causes energy consumption. Due to the mobility and portability of the mobile terminal, an effective method for battery charging is indispensable. Various techniques have been developed to reduce battery consumption during execution of an application in a mobile terminal, or to reduce battery consumption that occurs otherwise. Applications that may be executed in the mobile terminal include an application or a program for providing a time-based alarm to a user.

For example, in daily life, a time-based alarm function allows the user to recognize that it is a particular time so that when an alarm rings, the user may perform a corresponding task or action (i.e., a wake-up action, a conference, or the like). As location-based services have been added to the alarm function, there has developed a growing interest in a location-based alarm in addition to a time-based alarm. With the location-based alarm, a user can always know their current geographic location. Thus, if the resources of the mobile terminal (for example, the remaining battery capacity) are not limited, the user may be provided with an accurate location-based alarm service anytime and anywhere. However, due to the limited battery capacity of the mobile terminal, in reality, the user may not continuously recognize the user's location through the mobile terminal and much power consumption may be required to continuously find the user's location.

To address this problem, the related art provides a separate server to find the user's location, or the mobile terminal itself periodically finds the user's location.

Although the aforementioned method of finding the user's location through the server may provide an accurate location-based alarm service, certain development and maintenance costs related to an infrastructure necessary for communication with the server may be prohibitive. Moreover, continuous communication with the mobile terminal may be required to improve accuracy, requiring considerable battery consumption.

In addition, in the methods in the related art of periodically finding the user's location, there exists a correlation between accuracy and battery consumption according to the period which has been set. For example, if a period is set short, battery consumption increases as may accuracy. In contrast, if a period is set long, accuracy may decline. In the related art, there is also a method to find a user's location by using a time spent by another terminal which already uses a section of a path between an origin and a destination. However, this method may be restricted to use in transportation contexts having a predetermined origin and destination, such as a subway. In this case, in order to know the time spent by another terminal, a server needs to be used.

Therefore, a need exists for an apparatus and a method which more effectively reduces battery consumption in a mobile terminal.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for reducing battery consumption of a mobile terminal in providing a location-based alarm.

Another aspect of the present disclosure is to minimize battery consumption by reducing the number of times that a user locating operation is performed when providing a location-based alarm that is set by the user without the help of a server.

In accordance with an aspect of the present disclosure, a method for reducing battery consumption of a mobile terminal is provided. The method includes calculating a current location of the mobile terminal, route information to a destination, and an alarm period for determining whether the mobile terminal has arrived at the destination or at a nearby region of the destination, if the destination is input, and deactivating a locating module before the alarm period has elapsed, determining whether the mobile terminal has arrived at the destination or at the nearby region of the destination if the alarm period has elapsed, and notifying the user that the mobile terminal has arrived at the destination or at the nearby region of the destination if the mobile terminal has arrived at the destination or at the nearby region of the destination.

In accordance with another aspect of the present disclosure, a method for reducing battery consumption of a mobile terminal is provided. The method includes calculating a current location of the mobile terminal, route information to each of at least one destination, and an alarm period for determining whether the mobile terminal is near each destination, or at a nearby region thereof, if the at least one destination is input, deactivating a locating module before an alarm period corresponding to a destination has elapsed, determining whether a location of the mobile terminal is the destination or is at the nearby region thereof if the alarm period corresponding to the destination has elapsed, and notifying the user that the location of the mobile terminal is the destination or the nearby region thereof if the location of the mobile terminal is at the destination or is at the nearby region thereof, and re-calculating at least one of route information and an alarm period which corresponds to a destination that is not the destination previously selected from among the at least one destinations.

In accordance with another aspect of the present disclosure, an apparatus for reducing battery consumption of a mobile terminal is provided. The apparatus includes a display unit, a locating module, and a controller configured to calculate a current location of the mobile terminal, route information to a destination, and an alarm period for determining whether the mobile terminal arrives at the destination or at a nearby region of the destination, if the destination is input into the display unit, to deactivate the locating module before the alarm period has elapsed, to determine whether the mobile terminal has arrived at the destination or at the nearby region of the destination if the alarm period has elapsed, and to notify the user whether the mobile terminal has arrived at the destination or the nearby region of the destination.

In accordance with another aspect of the present disclosure, a computer-readable recording medium having recorded thereon a program comprising a command that, when executed, reduces battery consumption of a mobile terminal is provided. The computer-readable recording medium includes a first command configured to calculate a current location of the mobile terminal, route information to a destination, and an alarm period for determining whether the mobile terminal arrives at the destination or a nearby region of the destination, if the destination is input, and a second command configured to deactivate a locating module before the alarm period has elapsed, to determine whether the mobile terminal arrives at the nearby region of the destination if the alarm period has elapsed, and to notify the user whether the mobile terminal arrives at the nearby region of the destination.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic block diagram illustrating a mobile terminal according to an embodiment of the present disclosure;

FIG. 2 is a block diagram illustrating an apparatus for reducing battery consumption of a mobile terminal according to an embodiment of the present disclosure;

FIG. 3 is a diagram showing a designating of a destination according to an embodiment of the present disclosure;

FIG. 4 is a diagram showing a calculating of route information from a current location of a mobile terminal to a destination and displaying the route information according to an embodiment of the present disclosure;

FIG. 5 is a diagram illustrating that an alarm period is set during movement of a mobile terminal to a destination according to an embodiment of the present disclosure;

FIG. 6 is a flowchart illustrating a method for reducing battery consumption of a mobile terminal according to an embodiment of the present disclosure;

FIG. 7 is a diagram showing a comparison in a success rate between the related art and an embodiment of the present disclosure during a movement to a destination while reducing the number of Global Positioning System (GPS) accesses in order to reduce battery consumption of a mobile terminal; and

FIG. 8 is a diagram showing a comparison in the number of GPS accesses between the related art and an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although ordinal numbers such as “first,” “second,” and so forth will be used to describe various components of the present disclosure, those components are not limited by the terms. The terms are used only for distinguishing one component from another component. For example, a first component may be referred to as a second component and likewise, a second component may also be referred to as a first component, without departing from the teaching of the inventive concept. The term “and/or” used herein includes any and all combinations of one or more of the associated listed items.

The terminology used herein is for the purpose of describing an embodiment only and is not intended to be limiting of an embodiment. As used herein, the singular forms are intended to include the plural forms as well, unless the context clearly indicates otherwise. It will be further understood that the terms “comprises” and/or “has” when used in this specification, specify the presence of a stated feature, number, step, operation, component, element, or a combination thereof but do not preclude the presence or addition of one or more other features, numbers, steps, operations, components, elements, or combinations thereof.

The terms used herein, including technical and scientific terms, have the same meanings as terms that are generally understood by those skilled in the art, unless otherwise indicated the terms are differently defined. It should be understood that terms defined in a generally-used dictionary have meanings coinciding with those of terms in the related technology unless otherwise indicated.

Hereinafter, an operating principle of various embodiments of the present disclosure will be described. In the following description, a detailed description of well-known techniques related to the present disclosure will not be provided if it unnecessarily obscures the subject matter of the present disclosure. The terms used herein are defined considering their functions in the present disclosure, and they are subject to change according to users, intentions of the users, or user practice. Therefore, the terms used herein should be defined based on the overall contents of the specification.

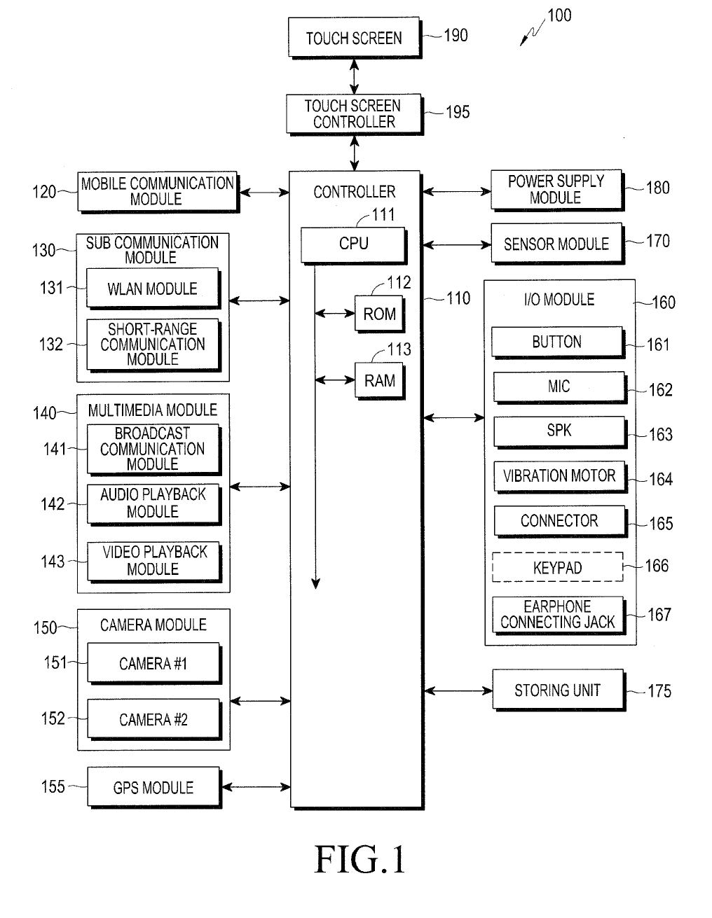

FIG. 1 is a schematic block diagram illustrating a mobile terminal according to an embodiment of the present disclosure.

Referring to FIG. 1, the mobile terminal 100 may be connected with an external device (not illustrated) by using an external device connection unit such as a sub communication module 130, a connector 165, and an earphone connecting jack 167. The “external device” may include various devices which are removable from the mobile terminal 100 and are connectible with the mobile terminal 100 in a wired manner, such as, for example, an earphone, an external speaker, a Universal Serial Bus (USB) memory, a charging device, a cradle/dock, a mobile payment-related device, a health management device (a blood pressure monitor or the like), a game console, a vehicle navigation device, and so forth. The “external device” may include one of a Bluetooth communication device that is wirelessly connectible to the mobile terminal 100 through short-range communication, a short-range communication device such as a Near Field Communication (NFC) device, a WiFi Direct communication device, and a wireless Access Point (AP). The “external device” may include one of another mobile terminal, a cellular phone, a smart phone, a tablet Personal Computer (PC), a desktop PC, and a server.

The mobile terminal 100 may be a smartphone, a cellular phone, a game console, a TV, a display device, a vehicle head unit, a laptop, a tablet PC, a Personal Media Player (PMP), a Personal Digital Assistant (PDA), or the like. The mobile terminal 100 may be implemented with a pocket-size portable mobile communication terminal having a wireless communication function.

The mobile terminal 100 includes a touch screen 190 and a touch screen controller 195. The mobile terminal 100 also includes a controller 110, a mobile communication module 120, the sub communication module 130, a multimedia module 140, a camera module 150, a Global Positioning System (GPS) module 155, an input/output module 160, a sensor module 170, a storing unit 175, and a power supply unit 180.

The sub communication module 130 includes at least one of a Wireless Local Area Network (WLAN) module 131 and a short-range communication module 132. The multimedia module 140 includes at least one of a broadcast communication module 141, an audio playback module 142 and a video playback module 143. The camera module 150 includes at least one of a first camera 151 and a second camera 152. The input/output module 160 includes at least one of the button 161, a microphone 162, a speaker 163, a vibration motor 164, the connector 165, a keypad 166, and the earphone connecting jack 167.

The controller 110 includes a Central Processing Unit (CPU) 111, a Read Only Memory (ROM) 112 in which a control program for controlling the mobile terminal 100 is stored, and a Random Access Memory (RAM) 113 which stores a signal or data input from the mobile terminal 100 or is used as a memory region for a task performed in the mobile terminal 100. The CPU 111 may include a single core, a dual core, a triple core, or a quad core processor. The CPU 111, the ROM 112, and the RAM 113 may be interconnected through an internal bus.

The controller 110 controls the mobile communication module 120, the sub communication module 130, the multimedia module 140, the camera module 150, the GPS module 155, the input/output module 160, the sensor module 170, the storing unit 175, the power supply unit 180, the touch screen 190, and the touch screen controller 195.

The mobile communication module 120, the sub communication module 130, and the broadcast communication module 141 of the multimedia module 140 may be collectively referred to as a communication unit that is provided for direct connection with an external device or connection over a network and may be a wired or wireless communication unit. The communication unit transmits data from the controller 110, the storing unit 175, and the camera module 150 in a wireless or wired manner, or receives data from an external communication line or the air in a wired or wireless manner to deliver the data to the controller 110 or store the data in the storing unit 175.

The mobile communication module 120 may facilitate the connection between the mobile terminal 100 and an external device through mobile communication by using at least one antenna (not illustrated) under control of the controller 110. The mobile communication module 120 transmits/receives a wireless signal for exchange or unidirectional transmission or reception of data such as a voice call, a video call, a text message (i.e., a Short Messaging Service (SMS)), and/or a multimedia message (Multimedia Messaging Service (MMS)) with a cellular phone (not illustrated), a smart phone (not illustrated), a tablet PC, or another device (not illustrated) which has a phone number or a network address input into the mobile terminal 100.

The sub communication module 130 includes the WLAN module 131 and the short-range communication module 132. Alternatively, the sub communication module 130 may include either the WLAN module 131 or the short-range communication module 132, or both.

The WLAN module 131 may be connected to the Internet in a place where a wireless AP (not illustrated) is installed, under control of the controller 110. The WLAN module 131 supports the wireless LAN standard IEEE802.11x of the Institute of Electrical and Electronics Engineers (IEEE). The short-range communication module 132 may wirelessly perform short-range communication between the mobile terminal 100 and an image forming apparatus (not illustrated) under control of the controller 110. The short-range communication may include Bluetooth, Infrared Data Association (IrDA), WiFi-Direct communication, NFC communication, or the like.

The mobile terminal 100 may include at least one of the mobile communication module 120, the WLAN module 131, and the short-range communication module 132, depending on its capability. For example, the mobile terminal 100 may include a combination of the mobile communication module 120, the WLAN module 131, and the short-range communication module 132 depending on its capability.

The multimedia module 140 may include the broadcast communication module 141, the audio playback module 142, or the video playback module 143. The broadcast communication module 141 receives a broadcast signal (for example, a TV broadcast signal, a radio broadcast signal, or a data broadcast signal) and broadcast additional information (for example, Electric Program Guide (EPG) or Electric Service Guide (ESG)) transmitted from a broadcasting station (not shown) via a broadcast communication antenna (not illustrated) under control of the controller 110.

The audio playback module 142 may play a digital audio file (for example, a file having a file extension such as ‘mp3’, ‘wma’, ‘ogg’, or ‘way’) stored or received through the speaker 163 under control of the controller 110. The video playback module 143 may play a digital video file (for example, a file having a file extension such as ‘mpeg’, ‘mpg’, ‘mp4’, ‘avi’, ‘mov’, or ‘mkv’) stored or received through the touchscreen 190 under control of the controller 110.

The multimedia module 140 may include the audio playback module 142 and the video playback module 143, except for the broadcast communication module 141. The audio playback module 142 and/or the video playback module 143 of the multimedia module 140 may be included in the controller 110.

The camera module 150 includes the first camera 151 and the second camera 152 which capture a still image or a video under control of the controller 110. The first camera 151 or the second camera 152 may include an auxiliary light source (for example, a flash that is not illustrated) for providing the amount of light necessary for photographing. The first camera 151 may be positioned on the front surface of the mobile terminal 100, and the second camera 152 may be positioned on the rear surface of the mobile terminal 100. In another embodiment, the first camera 151 and the second camera 152 may be positioned adjacent to each other (for example, a space between the first camera 151 and the second camera 152 is greater than 1 cm and less than 8 cm) to capture a three-Dimensional (3D) still image or a 3D moving image.

The first camera 151 and the second camera 152 each include a lens system, an image sensor, a flash, and so forth. The first camera 151 and the second camera 152 convert an optical signal (input or captured) through the lens systems into an electric image signal and output the electric image signal to the controller 110. The user may capture a moving image or a still image through the first camera 151 and the second camera 152.

A lens system forms an image of an object by converging external incident light. The lens system includes at least one lens that is a convex lens or an aspherical lens. The lens system is symmetrical with respect to an optical axis along the center of the lens system. The optical axis is defined as a central axis. The image sensor detects an optical image formed by external incident light as an electrical image signal. The image sensor is provided with a plurality of pixel units arranged in an M×N matrix and the pixel units include a photodiode and a plurality of transistors. The pixel units accumulate electric charges generated by the incident light and the voltage of the accumulated electric charges represents the luminance of the incident light. In processing a still image or an image of a video, an image signal output from the image sensor is a set of voltages (that is, pixel values) output from the pixel units. The image signal represents one frame (that is, a still image). The frame includes M×N pixels. The image sensor may be a Charge-Coupled Device (CCD) or Complementary Metal-Oxide Semiconductor (CMOS) image sensor.

A driver drives the image sensor under the control of the controller 110. The driver operates all of the pixels of the image sensor or the pixels of a region of interest among the whole pixels according to a control signal received from the controller 110, and outputs image data received from the pixels to the controller 110.

The controller 110 processes an image received from each of the first camera 151 and the second camera 152 or an image stored in the storing unit 175 on a frame basis, and outputs an image frame converted to match to the display characteristics of the touch screen 190 (for example, size, video quality, resolution, or the like). The controller 110 may also recognize movement of the mobile terminal 100 caused by user's movement and recognize a transportation means and movement thereof by using the moving speed and location of the transportation means when the user takes the transportation means such as a bus, a subway, a taxi, or the like.

The GPS module 155 receives electric waves from a plurality of GPS satellites (not illustrated) that orbit the Earth and calculates a position of the mobile terminal 100 (that is, the location of the user who has the mobile terminal 100) using time of arrival from the GPS satellite (not illustrated) to the mobile terminal 100. Although only the GPS module 155 is illustrated herein, this embodiment is merely an example, and a WiFi Positioning System (WPS) module may be provided like the GPS module 155 or one of the GPS module and the WPS module may be provided.

The input/output module 160 may include the at least one button 161, the microphone 162, the speaker 163, the vibration element 164, the connector 165, the keypad 166, and the earphone connecting jack 167. The input/output module 160, except for the connector 165, is used as a means for receiving a user input or providing information to a user, and as other examples of the input/output module 160, but not limited thereto, a cursor control such as a mouse, a track ball, a joy stick, or a cursor direction key may be provided to control information communication with the controller 110 and movement of a cursor on the touch screen 190.

The buttons 161 may be formed on at least one of a front surface 100a, a side surface 100b, and a rear surface 100c of the mobile terminal 100, and may include at least one of a power button 161d, a volume button 161e including a volume-up button 161f and a volume-down button 161g, a menu button 161b, a home button 161a, a back button 161c, and a search button.

The microphone 162 receives voice or sound from the user or a surrounding environment and generates a corresponding electric signal under control of the controller 110.

The speaker 163 outputs sound corresponding to various signals (for example, wireless data, broadcast data, a digital audio file, a digital video file, a picture, or the like) of the mobile communication module 120, the sub communication module 130, the multimedia module 140, or the camera module 150 under control of the controller 110. The speaker 163 may output sound corresponding to a function executed by the mobile terminal 100 (for example, button manipulation sound corresponding to a phone call, or a ring back tone). One or more speakers 163 may be formed in a proper position or proper positions of the mobile terminal 100.

The vibration motor 164 converts an electric signal into mechanical vibration under control of the controller 110. For example, in the mobile terminal 100, in a vibration mode, if a voice call or a video call from another device (not illustrated) is received, the vibration motor 164 operates. One or more of the vibration element 164 may be disposed in the mobile terminal 100. The vibration element 164 may operate in response to a user's touch action of touching the touch screen 190 and a continuous movement of a touch on the touch screen 190.

The connector 165 may be used as an interface for connecting the mobile terminal 100 with an external device (not illustrated) or a power source (not illustrated). Under control of the controller 110, the mobile terminal 100 transmits data stored in the storing unit 175 of the mobile terminal 100 to an external device (not illustrated) or receives data from the external device through a wired cable connected to the connector 165. The mobile terminal 100 receives power from the power source (not illustrated) through the wired cable connected to the connector 165 or charges a battery (not illustrated) by using the power source.

The keypad 166 receives key input from the user for control of the mobile terminal 100. The keypad 166 includes a physical keypad (not illustrated) formed in the mobile terminal 100 or a virtual keypad (not illustrated) displayed on the touch screen 190. The physical keypad (not illustrated) formed in the mobile terminal 100 may be excluded according to the capability or structure of the mobile terminal 100.

An earphone (not illustrated) may be inserted into the earphone connecting jack 167 to be connected to the mobile terminal 100.

The sensor module 170 includes at least one sensor for detecting a state (position, direction, movement, and so forth) of the mobile terminal 100. For example, the sensor module 170 may include at least one of a proximity sensor for detecting the user's proximity with respect to the mobile terminal 100, an illumination sensor (not illustrated) for detecting an amount of light around the mobile terminal 100, a motion/direction sensor (not illustrated) for detecting an operation of the mobile terminal 100 (for example, rotation, acceleration, deceleration, or vibration of the mobile terminal 100), an altimeter for measuring an atmospheric pressure to detect an altitude, a geo-magnetic sensor (not illustrated) for detecting a point of the compass by using the Earth's magnetic field, a gravity sensor for detecting a working direction of the gravity, a shock sensor, a compass sensor, and an acceleration sensor. The sensor module 170 detects a state of the mobile terminal 100 and generates a signal corresponding to the detection to output the signal to the controller 110. The sensor of the sensor module 170 may be added or removed depending on the capability of the mobile terminal 100.

The storing unit 175 stores a signal or data which is input/output to/from the mobile communication module 120, the sub communication module 130, the multimedia module 140, the camera module 150, the GPS module 155, the input/output module 160, the sensor module 170, or the touch screen 190, under control of the controller 110. The storing unit 175 may also store a control program and applications for control of the mobile terminal 100 and/or the controller 110.

The term “storing unit” includes the storing unit 175, the ROM 112 and the RAM 113 in the controller 110, or a memory card (not illustrated) mounted in the mobile terminal 100 (for example, a Secure Digital (SD) card, a memory stick).

The storing unit 175 may also store applications of various functions such as navigation, video communication, games, an alarm application based on time, images for providing a Graphic User Interface (GUI) related to the applications, user information, documents, databases or data related to a method for processing touch inputs, background images (e.g., a menu screen, a standby screen, and so forth), operation programs necessary for driving the mobile terminal 100, and images captured by the camera module 150. The storing unit 175 is a machine, such as, for example, a non-transitory computer-readable medium. The term “machine-readable medium” includes a medium for providing data to the machine to allow the machine to execute a particular function. The machine-readable medium may be a storage medium. The storing unit 175 may include non-volatile media or volatile media. Such a medium needs to be of a tangible type so that commands delivered to the medium can be detected by a physical tool which reads the commands with the machine.

The machine-readable medium may include, but is not limited to, at least one of a floppy disk, a flexible disk, a hard disk, a magnetic tape, a Compact Disc Read-Only Memory (CD-ROM), an optical disk, a punch card, a paper tape, a RAM, a Programmable Read-Only Memory (PROM), an Erasable PROM (EPROM), and a flash EPROM.

The power supply unit 180 supplies power to one or more batteries disposed in the mobile terminal 100 under control of the controller 110. The one or more batteries supply power to the mobile terminal 100. The power supply unit 180 may also supply power input from an external power source (not illustrated) through the wired cable connected with the connector 165 to the mobile terminal 100. The power supply unit 180 may also supply power, which is wirelessly input from an external power source using a wireless charging technique, to the mobile terminal 100.

The touch screen 190 displays data input from the controller 110 to the user, and provides a GUI corresponding to various services (for example, call, data transmission, broadcasting, picture taking) to the user. The touch screen 190 delivers an analog signal corresponding to at least one touch input or hovering input for the GUI to the touch screen controller 195.

The touch screen 190 receives at least one input through a user input means (for example, a finger).

The touch screen 190 receives a continuous movement of a touch (i.e., a drag). The touch screen 190 delivers an analog signal corresponding to the received continuous movement of the touch to the touch screen controller 195.

A pen (not illustrated) may be provided in a lower end portion of the mobile terminal 100. The pen may be inserted into the mobile terminal 100 for keeping, and when being used, may be withdrawn or separated from the mobile terminal 100. In a region of an inner side of the mobile terminal 100 into which the pen is inserted, an attach/detach recognition switch (not illustrated) operating according to attachment or detachment of the pen is disposed to provide a signal corresponding to attachment or detachment of the pen to the controller 110.

In the present disclosure, an input to the touch screen 190 is not limited to a direct contact between the touch screen 190 and a user input means (for example, a finger or the pen) and may also include a non-contact touch (for example, a distance between the touch screen 190 and the user input means is less than 1 cm). A distance or interval from the touch screen 190 within which the user input means may be detected may be changed according to the capability or structure of the mobile terminal 100. In particular, to separately detect a direct touch event based on a contact with the user input means and non-contact touch event (for example, a hovering event), the touch screen 190 and/or the pen may be configured to output different values for the intervals (or contact or non-contact) between the touch screen 190 and the user input means. That is, the touch screen 190 is configured to differently output a value detected by the touch event (for example, a current value, a voltage value, a resistance value, a capacitance value, or the like) and a value detected by the hovering event.

The touch screen controller 195 converts an analog signal received from the touch screen 190 to a digital signal (for example, X and Y coordinates and an input strength value (or a detection value)) and delivers the digital signal to the controller 110. The controller 110 may control the touch screen 190 using the digital signal received from the touch screen controller 195. For example, the controller 110 may control selection or execution of a shortcut icon (or an application corresponding thereto) displayed on the touch screen 190 in response to a touch event or a hovering event. The touch screen controller 195 may be incorporated into the controller 110 or the touch screen 190.

The touch screen controller 195 calculates a distance between the user input means and the touch screen 190 based on a value output from the touch screen 190, converts the calculated distance into a digital signal (for example, a Z coordinate), and provides the digital signal to the controller 110.

The touch screen controller 195 determines contact or non-contact between the user input means and the touch screen 190 based on a value output from the touch screen 190, converts a value indicating contact or non-contact into a digital signal, and provides the digital signal to the controller 110.

The touch screen 190 may include at least two touch panels capable of sensing an input by a passive first user input means (that is, a part of a human body such as a finger), that is, a finger input, and an input by an active second user input means (that is, a pen), that is, a pen input, respectively, to differently detect the finger input and the pen input. Classification of the user input means into the passive type and the active type depends on whether the user input means may produce or induce and output energy such as electromagnetic waves. The at least two touch panels provide different output values to the touch screen controller 195. Thus, the touch screen controller 195 differently recognizes the values input from the at least two touch screen panels to identify whether the input from the touch screen 190 is the input generated by the finger or by the pen. For example, the structure of the touch screen 190 may be a combination of a capacitive touch screen panel and an ElectroMagnetic Resonance (EMR) touch screen panel. In addition, the touch screen 190 may be configured to include touch keys such as the menu button 161b, the back button 161c, and the like as described above, such that the finger input referred herein or the finger input on the touch screen may include a touch input on the touch keys. Hereinbelow, an apparatus for reducing battery consumption of the mobile terminal 100 will be described.

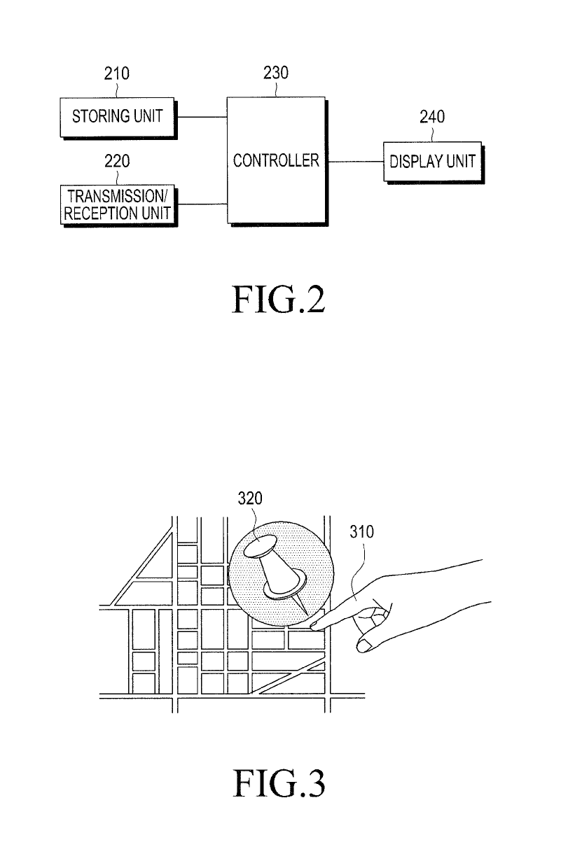

FIG. 2 is a block diagram illustrating an apparatus for reducing battery consumption of the mobile terminal according to an embodiment of the present disclosure.

Referring to FIG. 2, the apparatus for reducing battery consumption of the mobile terminal 100 may include a storing unit 210 for storing a location-based alarm application, a display unit 240 for displaying the location-based alarm application and receiving a destination from the user, a transmission/reception unit 220 for receiving information such as a current location of the mobile terminal 100 and a current time, and a controller 230 for calculating and/or analyzing at least one of a distance between the current location of the mobile terminal 100 and the destination, an expected time (or period) of arrival at the destination, a transportation means used to move to the destination, and the moving speed of the mobile terminal 100.

Once the destination is input from the user through the display unit 240 of the mobile terminal 100, the controller 230 calculates at least one of the current location of the mobile terminal 100, route information to the input destination, and an alarm time (or period) for determining whether the user is located at the destination or a nearby region of the destination. The controller 230 deactivates a locating module, e.g., the GPS module or the WPS module included in the transmission/reception unit 220, before the alarm period has elapsed, and determines whether the user is at the destination or a nearby region of the destination if the alarm period has elapsed, and notifies the user that the user is at the destination or at a nearby region of the destination if so.

If a transportation means of the user is changed after the user registers the destination, the controller 230 re-calculates at least one of the route information to the destination and the alarm period by applying at least one of the moving speed and a location of the new transportation means. Thereafter, if the alarm period has elapsed, the controller 230 activates the locating module to re-calculate at least one of the current location of the mobile terminal 100, the route information to the destination, and an expected period of arrival and to reset an alarm period that is shorter than the expected period of arrival. For example, if an expected period of arrival from an origin to a destination A is 1 hour, an alarm period is set to 40 minutes, which is shorter than the expected period of arrival. If the set alarm period, 40 minutes, has passed during movement to the destination A, it is determined whether the current location of the mobile terminal 100 is at the destination A or a nearby region thereof, such that if the current location of the mobile terminal 100 is not either at the destination A or in the nearby region thereof, an expected period of arrival at the destination A from the current location of the mobile terminal 100 is re-calculated. If the re-calculated expected period of arrival is 20 minutes, the alarm period is reset to 14 minutes which is shorter than the expected period of arrival of 20 minutes. The alarm period may be set to have a predetermined rate with respect to the expected period of arrival, or may be set by the user.

If one of one or more input destinations (e.g., an arbitrary destination) is selected and a user is notified that the user arrives at a nearby region of the selected destination if the alarm period has elapsed, then route information and alarm periods corresponding to the other destinations are updated using route information and an alarm period corresponding to the selected destination. For example, suppose that an alarm period corresponding to the destination A from an origin is 1 hour, an alarm period corresponding to a destination B from the origin is 2 hours, and an expected period of arrival at the destination B from the destination A is 1 hour. Then, if the mobile terminal 100 arrives at the destination A, the alarm period corresponding to the destination B is updated from 2 hours from the origin into 1 hour. The route information is also updated in this way.

Although FIG. 2 illustrates rough blocks for reducing battery consumption of the mobile terminal 100, such illustration is merely to illustrate an embodiment, and the blocks illustrated in FIG. 2 may perform functions performed in corresponding blocks illustrated in FIG. 2.

For example, the transmission/reception unit 220 of FIG. 2 may include the mobile communication module 120, the sub-communication module 130, and the GPS module 155 of FIG. 1, and may also include a module for transmitting and receiving data through various communication protocols, such as the Internet, Wireless Broadband (Wibro), Wireless Internet Platform for Interoperability (WiPi), and so forth, as well as various modules for providing communication with peripheral devices of the mobile terminal 100.

The storing unit 210 may also store applications of various functions such as navigation, video communication, games, images for providing a GUI related to the applications, user information, documents, databases or data related to a method for processing touch inputs, background images or operation programs necessary for driving the mobile terminal 100, and may also store a location-based alarm application that registers a user's current location and one or more destinations and designates or displays a time of arrival at a destination, a distance to the destination, a transportation means for arrival at the destination, and a moving speed for arrival at the destination.

The display unit 240 may include a touch screen that displays data to the user, provides a GUI corresponding to various services (for example, call, data transmission, broadcasting, picture taking) to users, and receives an analog signal corresponding to at least one touch input or hovering input for the GUI. Through the touch screen, the user may designate or input a destination for which a location-based alarm is to be generated.

With reference to FIG. 2, a description will now be made of the apparatus for reducing battery consumption of the mobile terminal 100 according to an embodiment of the present disclosure.

Once the user executes a location-based alarm application to input a destination for which a location-based alarm is to be generated or to know a current location, the controller 230 reads the application from among a plurality of programs or applications stored in the storing unit 210 to display the application on the display unit 240. If the user inputs a plurality of destinations to go to a plurality of destinations, the plurality of destinations may be displayed on the location-based alarm application, and timers may be driven for the plurality of destinations, respectively. The controller 230 provides the current location of the mobile terminal 100, received through the transmission/reception unit 220, on the location-based alarm application displayed on the display unit 240, to enable the user to know the user's current location.

If the destination is designated or input in to the displayed location-based alarm application from the user, the controller 230 calculates or recognizes a distance between the current location of the mobile terminal 100 and the destination, a time of arrival at the destination, the moving speed of the mobile terminal 100, and a transportation means used to move to the destination, and displays them on the displayed location-based alarm application. To recognize various information related to the current location and the destination, recognition of the current location needs to be performed first. The current location is received through the transmission/reception unit 220. The transmission/reception unit 220 periodically or aperiodically receives the current location of the mobile terminal 100 through the GPS module for receiving the current location of the mobile terminal 100 from a satellite or the WPS module for receiving the current location of the mobile terminal 100 using information of a wireless AP input through WiFi.

The controller 230 calculates a distance between a destination designated, input, or registered by the user and the current location to display various information related to the current location and to the destination on the location-based alarm application, and calculates an expected period of arrival based on the calculated distance. Upon calculating the expected period of arrival, the controller 230 sets an alarm period. The expected period of arrival is calculated considering a transportation means (for example, a walk, a bicycle, a bus, a subway, a taxi, or the like) the user may use to move to the destination. The controller 230 determines whether the mobile terminal 100 is at the destination or a nearby region of the destination and, if so, the controller 230 notifies the user that the mobile terminal 100 is at the destination or the nearby region thereof, and to this end, the alarm period is set and it is terminated earlier than (or is shorter than) an expected period of arrival. If the alarm period is set, the mobile terminal 100 does not check the current location of the mobile terminal 100 during the set alarm period, thus preventing battery consumption. Once the alarm period has elapsed, the controller 230 recognizes the user's current location, such that by using at least one of a sound, a vibration, and a pop-up of the mobile terminal 100, the controller 230 notifies the user that the user is at the destination or the nearby region thereof if so, and the user recognizes that the user is at the destination or the nearby region thereof. The nearby region of the destination is a region for providing a location-based alarm to the user and may be within a radius of, e.g., 100 meters to 500 meters from the destination. The nearby region of the destination may be set or changed by the user or by a mobile terminal manufacturer. The expected period of arrival may vary according to a transportation means to the destination. If the transportation means is changed, the controller 230 senses such change of the transportation means and re-calculates the expected period of arrival. The controller 230 may also display the calculated expected period of arrival on the location-based alarm application if necessary. The transportation means may be input from the user or may be recognized using at least one of a posture, a movement, a direction, a moving speed, a route, and a signal strength of the mobile terminal 100. The mobile terminal 100 may also recognize the continuous use or a change of the transportation means based on frequency corresponding to an ambient sound, a pass in a case of use of public transportation, a regularity or irregularity of the moving speed, and a signal generator mounted in advance on the transportation means. If the transportation means is changed, the mobile terminal 100 re-calculates and/or re-sets the expected period of arrival and the alarm period. The pass refers to, e.g., an electronic ticket, such as a transportation card, for using public transportation. When public transportation is used with a tag mounted in the mobile terminal 100, a public transportation means may be identified using the tag and the signal generator may be a device mounted in advance on the transportation means to output information including a type of the transportation means, such that the mobile terminal 100 may identify the transportation means upon receiving the information including the type of the transportation means output from the signal generator. Once the expected period of arrival and the alarm period are calculated and/or set, the controller 230 does not check the user's location during the alarm period. The mobile terminal 100 does not check the user's current location during the alarm period, thereby preventing unnecessary battery consumption of the mobile terminal 100. Checking the current location involves activating the GPS module to analyze the current location so as to know the current location of the mobile terminal 100 according to the moving state of the mobile terminal 100.

Hereinafter, a process of calculating the alarm period will be described.

Once the user inputs the destination, the controller 230 reads GPS or WPS information stored in the storing unit 210 to recognize the current location of the mobile terminal 100 or request the current location of the mobile terminal 100 through the transmission/reception unit 220. Upon recognizing the current location of the mobile terminal 100, the controller 230 calculates or analyzes at least one of a moving distance, a moving time, a moving speed, an alarm period, and a transportation means between the recognized current location and the destination and a time of arrival at the destination.

The alarm period is a sum of the current time and a minimum time during which the GPS module is deactivated (or a minimum deactivation time), in which the minimum time is determined by using the quotient of the distance between the current location and the destination divided by the moving speed of the mobile terminal 100. The alarm period is calculated by using Equation (1).

W=T+min[Pᵢ] Equation (1)

In Equation (1), W represents an alarm period and T represents a current time. [Pᵢ] is calculated using Equation (2) provided below. As mentioned previously, the alarm period is set to a sum of the current time and the minimum deactivation time min [Pᵢ].

Pᵢ=SF_{type}d(Lᵤₛₑᵣ,Lᵢ)/V(M_{type}) Equation (2)

In Equation (2), Pᵢ represents a deactivation time for an i^{th} alarm period, Lᵤₛₑᵣ represents a user's current location, Lᵢ represents an i^{th} destination for the alarm period, M_{type} represents a type of a transportation means, such as a walk, a bicycle, a bus, a subway, a taxi, or the like, d(A,B) represents a distance between a location A and a location B, v(C) represents a nominal moving speed of the transportation means type C, and SF_{type} represents a scale factor.

The controller 230 calculates the alarm period using Equation (1) and Equation (2), and such calculation may be performed when the user's moving state is changed.

After the alarm period is calculated for the destination through the foregoing process, if the alarm period has elapsed, the mobile terminal 100 recognizes the current location and notifies the user of the recognized current location if the user is at the destination or the nearby region of the destination. Otherwise, if the user is not at the destination or at the nearby region of the destination, the mobile terminal 100 re-calculates a time required for arrival at the destination from the user's current location and repeats the aforementioned process. This process may be repeated until the mobile terminal 100 arrives at the destination or the nearby region of the destination.

After the alarm period is calculated for the destination through the foregoing process, if the alarm period has elapsed, the mobile terminal 100 recognizes the user's current location and notifies the user of the recognized current location if the user is at the destination or the nearby region of the destination. Otherwise, if the user is not at the destination or the nearby region of the destination, the mobile terminal 100 re-calculates an expected period of arrival (for example, 20 minutes) at the destination from the current location and sets the alarm period to a time (for example, 10 minutes) that is shorter than the expected period of arrival. This process may be repeated until the mobile terminal 100 arrives at the destination or at the nearby region of the destination, or may be repeated the limited number of times.

A description will now be made of cases when the alarm period is calculated or re-calculated according to the moving state of the mobile terminal 100 to the destination.

A description of when the moving state is not changed using a transportation means is as follows.

In this case, after the user registers one or more destinations in the location-based alarm application, the expected period of arrival and the alarm period are calculated and, in this state, the user moves to the destination without changing a moving speed and a route for the transportation means. In this case, the initially calculated expected period of arrival and alarm period are not changed. If the alarm period has elapsed, the user's current location is recognized, such that the user is notified that the user is at the destination or at the nearby region thereof, if so.

A description of when the transportation means is changed during movement to the destination is as follows.

In this case, after the user registers one or more destinations in the location-based alarm application, the expected period of arrival and the alarm period are calculated and, in this state, the user moves to the destination while changing moving speed and route for the transportation means. In this case, the initially calculated expected period of arrival and alarm period may be changed, and if the alarm period has elapsed, the user's current location is recognized such that the user is notified that the user is at the destination or at the nearby region thereof, if so.

A description of when the mobile terminal 100 does not move after the destination is designated is as follows.

In this case, after the destination is designated, the mobile terminal 100 does not move at all. After the user designates one or more destinations, the user stays in the current location. When the mobile terminal 100 starts moving, the mobile terminal 100 calculates the time during which the mobile terminal 100 has not moved at all to re-set or to update an alarm period and an expected period of arrival for the one or more destinations by using the calculated time.

FIG. 3 is a diagram showing a designating of a destination according to an embodiment of the present disclosure.

Referring to FIG. 3, a method for designating a destination according to an embodiment of the present disclosure may input the destination on a map by using a touch, for example, with a finger or a pen, or by using a keypad. However, the present disclosure is not limited to such inputs, and may also be applied to when the destination is input using any tool or function for designating the destination. Moreover, a plurality of destinations may be designated and the location-based alarm application may display the plurality of destinations. In FIG. 3, an example of designating a destination using a finger 310 according to an embodiment of the present disclosure is depicted, and once the destination is designated on the location-based alarm application in this way, an icon 320 indicating the destination is created to allow the user to know that the location indicated by the icon 320 is the destination. The icon 320, although having the shape of a tack, is merely an example, and the present disclosure may also include various shapes of icons indicating a destination.

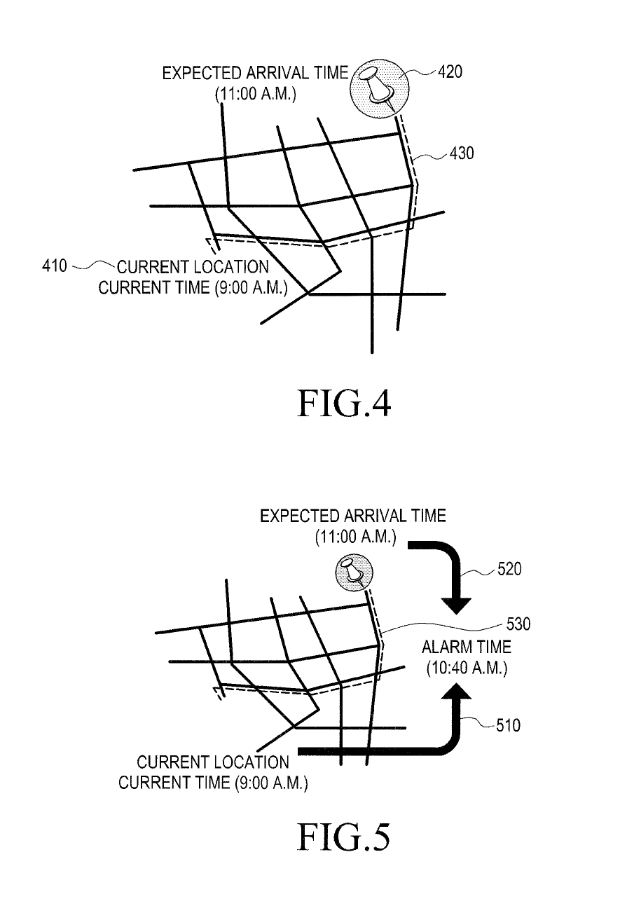

FIG. 4 is a diagram showing a calculating of route information from the current location of the mobile terminal to the destination and displaying the route information according to an embodiment of the present disclosure.

Referring to FIG. 4, a description will be made of the feature of calculating route information from the current location of the mobile terminal 100 to the destination and displaying the route information according to an embodiment of the present disclosure.

As described with reference to FIG. 3, if one or more destinations 420 are input, the mobile terminal 100 calculates route information from a current location 410 of the mobile terminal 100 to the input one or more destinations 420, and displays the calculated route information on a location-based alarm application. The route information includes at least one of an expected period of arrival at the destination, a distance between the current location and the destination, an available transportation means, an expected period of arrival corresponding to a transportation means, and an alarm period. The route information corresponding to the one or more destinations is stored in the storing unit 210. In FIG. 3, a moving route 430 from the current location 410 to the destination 420, a current time (9:00 a.m.), and an expected period of arrival (11:00 a.m.) are indicated. If the mobile terminal 100 starts moving, the moving route 430 may be displayed in real time. If a transportation means is changed, the expected period of arrival may also be changed by calculating a time of arrival using the new transportation means and the moving route 430 may also be changed.

FIG. 5 is a diagram illustrating that an alarm period is set during movement of the mobile terminal to the destination according to an embodiment of the present disclosure.

Referring to FIG. 5, a description will be made of an example in which an alarm period is set during a movement of the mobile terminal to the destination according to an embodiment of the present disclosure.

That is, an expected arrival time 520 is 11:00 a.m., and an alarm time 530 for notifying the user that the user is located near the destination is 10:40 a.m. The alarm time 530 (that is, 10:40 a.m.) is 1 hour and 40 minutes later than a current time 510 (that is, 9:00 a.m.) and is 20 minutes earlier than the expected arrival time 520 (that is, 11:00 a.m.). In this way, the alarm time is set 1 hour and 40 minutes later than the current time (9:00 a.m.), a gap of 20 minutes exists between the expected arrival time and the alarm time, and such a gap may be set by the user or by the mobile terminal 100. If the alarm period (that is, 1 hour and 40 minutes) has elapsed from the current time (that is, a departure time, 10:40 a.m.), the mobile terminal 100 recognizes the current location and notifies the user that the current location is the destination or the nearby region thereof, if so.

If the current location of the mobile terminal 100 is not the destination or the nearby region thereof, route information from the current location to the destination and the expected period of arrival are re-calculated. Upon calculation of the expected period of arrival, the alarm period is set to be terminated earlier than (or is shorter than) the expected period of arrival. The calculated route information and expected period of arrival may be displayed on the location-based alarm application. This process may be repeated until the mobile terminal 100 arrives at the destination or the nearby region thereof. If a plurality of destinations is set, route information corresponding to the respective destinations may be calculated respectively and the expected period of arrival may also be set to as many as there are destinations. If the mobile terminal 100 arrives at a nearby region of a destination and an alarm period corresponding to that destination has elapsed, then route information corresponding to the other destinations may be updated and stored.

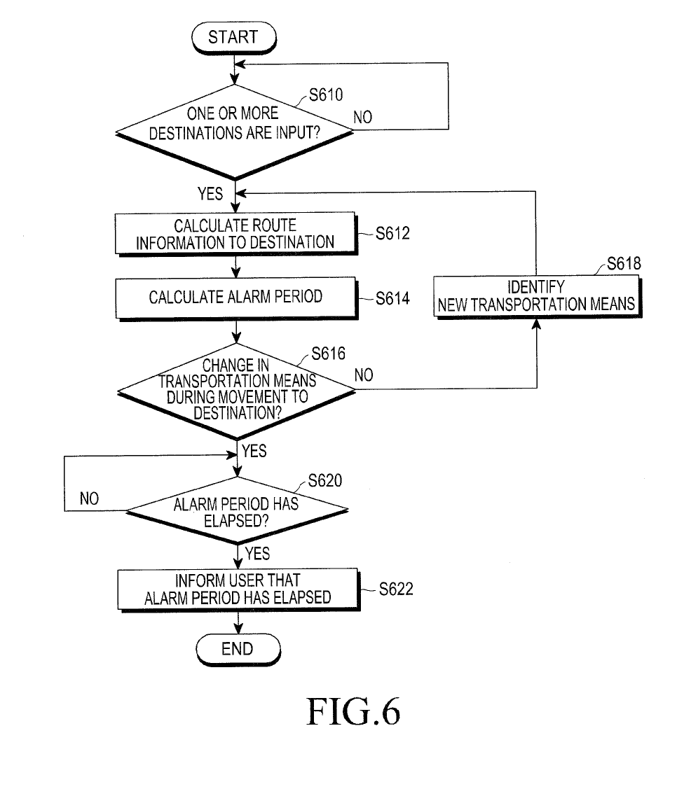

FIG. 6 is a flowchart illustrating a method for reducing battery consumption of the mobile terminal according to an embodiment of the present disclosure.

Referring to FIG. 6, once one or more destinations are input in operation S610, route information to the input one or more destinations is calculated in operation S612. The route information includes at least one of an expected period of arrival at the destination, a distance between a current location and the destination, an available transportation means, an expected period of arrival corresponding to a transportation means, and an alarm period. If the route is changed and thus the expected period of arrival or the alarm period is changed, the new expected period of arrival or the new alarm period may be included in the route information.

In operation S614, the alarm period is calculated to indicate to the user that the current location approaches the destination. The alarm period is generally set to be terminated earlier than (i.e., or to be shorter than) the expected period of arrival, but it may also be set to be later than (i.e., or to be longer than) the expected period of arrival. The alarm period may be set to have a short gap with the expected period of arrival if the distance between the origin and the destination is short, but if the distance between the origin and the destination is long, the alarm period may be set to have a long gap with the expected period of arrival.

In operation S616, a change in transportation means during movement to a destination may be detected.

If the transportation means is changed during movement to the destination, the new transportation means is identified in operation S618. The mobile terminal 100 may include various sensors capable of sensing a posture, a movement, a direction, a moving speed, a location, an altitude, and so forth of the mobile terminal 100, and the change of the transportation means may be recognized using the sensors. The change of the transportation means may also be recognized using a regularity and/or an irregularity of the moving speed of the mobile terminal 100. If the transportation means using public transportation such as a bus or a subway is changed, the mobile terminal 100 may analyze a subway running sound or an ambient sound that is input through the microphone 162 to identify the transportation means, or may use a tag provided in the mobile terminal 100 or a signal generator mounted in the transportation means to identify the transportation means.

If the transportation means is not changed in operation S616, it is monitored whether the alarm period has elapsed in operation S620. If the alarm period has elapsed, the current location is recognized and if the current location is the destination or the nearby region thereof, the user is informed that the user is near the destination in operation S622.

The present disclosure also indicates to the user that the user is at the destination or the nearby region thereof by using sound, vibration, pop-up, or other ways the human may perceive. When the user is not either at the destination or the nearby region thereof, the route information to the destination and the alarm period are re-calculated. This process may be repeated until the mobile terminal 100 finally arrives at the destination.

The present disclosure may recognize the user's location after the alarm period corresponding to one destination has elapsed, and then update and store expected times of arrivals and alarm periods for the other destinations.

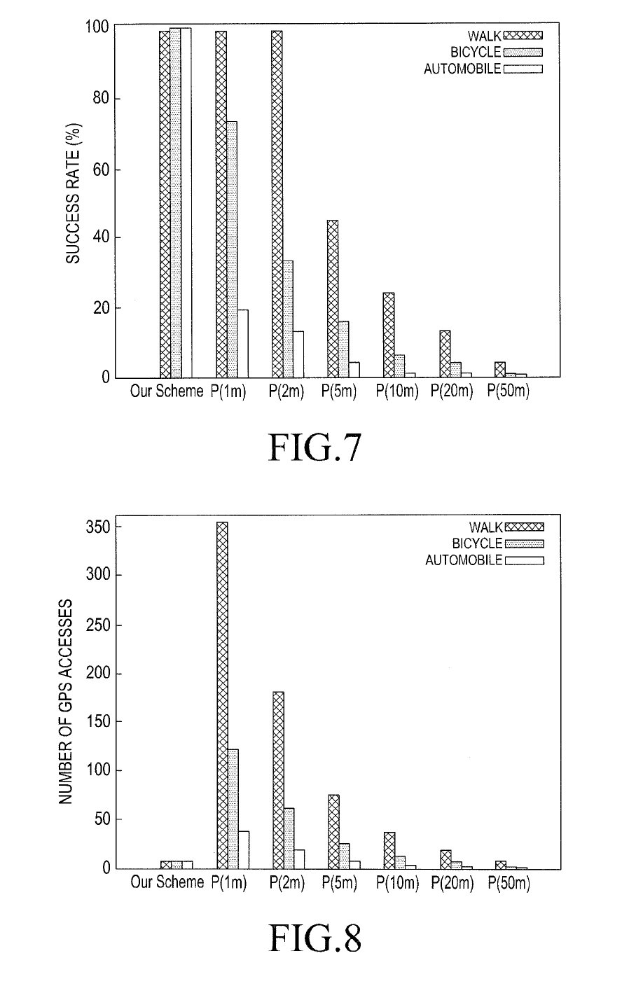

FIG. 7 is a diagram showing a comparison in a success rate between the related art and an embodiment of the present disclosure during a movement to a destination while reducing the number of GPS accesses in order to reduce battery consumption of a mobile terminal.

Referring to FIG. 7, an X axis indicates a time unit (that is, in minutes) for activating the GPS module, and a Y axis indicates a success rate of normal arrival at a nearby region of a destination. Comparison was performed among walking, a bicycle, and an automobile. As illustrated in FIG. 7, the present disclosure has a success rate of close to 100% during a movement to a destination using one of walking, a bicycle, and an automobile, whereas the related art has a success rate of close to 100% only when the GPS module is activated every minute or every two minutes, and experiences a decline in success rate when a bicycle or an automobile is used, or a when a time unit for activating the GPS module increases. Thus, as can be seen from test results, the present disclosure has a higher success rate of arrival at a nearby region of a destination than that of the related art.

FIG. 8 is a diagram showing a comparison in the number of GPS accesses between the related art and an embodiment of the present disclosure.

Referring to FIG. 8, an X axis indicates a time unit (that is, in minutes) for activating a GPS module, and a Y axis indicates the number of accesses to the GPS module by activating the GPS module until an arrival at a nearby region of a destination. As can be seen from FIG. 8, for the present disclosure, the number of GPS accesses is a relative few during movement to the destination using one of walking, a bicycle, and an automobile, whereas for the related art, the number of GPS accesses reaches 350 when a GPS access is attempted every minute during movement to the destination on foot. Moreover, in the related art, as the time unit increases, the number of GPS accesses decreases. Nevertheless, the number of GPS accesses also in this case is larger than that of the present disclosure.

It can be seen that various embodiments of the present disclosure may be implemented with hardware, software, or a combination of hardware and software. Such arbitrary software may be stored, whether or not erasable or re-recordable, in a volatile or non-volatile storage such as a Read-Only Memory (ROM); a memory such as a RAM, a memory chip, a device, or an integrated circuit; and an optically or magnetically recordable and machine (e.g., computer)-readable storage medium such as a Compact Disc (CD), a Digital Versatile Disk (DVD), a magnetic disk, or a magnetic tape. It can be seen that a memory that may be included in the mobile terminal is an example of a machine-readable storage medium which is suitable for storing a program or programs including instructions for implementing the various embodiments of the present disclosure. Therefore, the present disclosure includes a program including codes for implementing an apparatus or method claimed in an arbitrary claim and a machine-readable storage medium for storing such a program. The program may be electronically transferred through an arbitrary medium such as a communication signal delivered through wired or wireless connection, and the present disclosure properly includes equivalents thereof.

The mobile terminal may receive and store the program from a program providing device connected in a wired or wireless manner. The program providing device may include a memory for storing a program including instructions for instructing mobile terminal to execute the claimed method, a communication unit for performing wired or wireless communication with the mobile terminal, and a controller for transmitting a corresponding program to a host device at the request of the mobile terminal or automatically.

According to an embodiment of the present disclosure, by providing an apparatus and method for reducing battery consumption of a mobile terminal, a location-based alarm service may be provided merely with the mobile terminal without a need for a separate server, and the usability of the location-based alarm service may be improved.

Other effects that may be obtained or expected from the embodiment of the present disclosure are explicitly or implicitly disclosed in the detailed description of the embodiment of the present disclosure. That is, various effects expected from the embodiment of the present disclosure have been disclosed in the detailed description of the present disclosure.

While the present disclosure has been shown and described with reference to various embodiments thereof, it will be understood by those skilled in the art that various changes in form and detail may be made therein without departing from the spirit and scope of the present disclosure as defined by the following claims and their equivalents.

What is claimed is:

1. A method for reducing battery consumption in a mobile terminal, the method comprising:
calculating a current location of the mobile terminal, route information to a destination, and an alarm period for determining whether the mobile terminal has arrived at the destination or at a nearby region of the destination, if the destination is input; and
deactivating a locating module before the alarm period has elapsed, determining whether the mobile terminal has arrived at the destination or at the nearby region of the destination if the alarm period has elapsed, and notifying the user that the mobile terminal has arrived at the destination or at the nearby region of the destination if the mobile terminal has arrived at the destination or at the nearby region of the destination.

2. The method of claim 1, further comprising:
re-calculating at least one of the route information to the destination and the alarm period by applying at least one of a moving speed and a location of a new transportation means, if a transportation means for moving to the destination is changed.

3. The method of claim 1, further comprising:
re-calculating at least one of the current location of the mobile terminal, the route information to the destination, and the alarm period by activating the locating module, if the alarm period has elapsed.

4. The method of claim 1, wherein one or more steps are repeated until the mobile terminal arrives at the destination or at the nearby region of the destination.

5. The method of claim 1, wherein the alarm period is a sum of a current time and a minimum time for which the locating module is deactivated.

6. The method of claim 5, wherein the minimum time is determined using a quotient of a distance between the current location and the destination divided by a moving speed of the mobile terminal.

7. The method of claim 2, wherein the transportation means is identified using at least one of a posture, a movement, a direction, a moving speed, a route, a signal strength, an ambient noise, a moving speed regularity, and a moving speed irregularity of the mobile terminal.

8. The method of claim 1, wherein the route information comprises at least one of a distance between the current location and the destination, a transportation means to the destination, an expected period of arrival corresponding to the transportation means, and the alarm period.

9. The method of claim 1, wherein the nearby region is a region formed by an adjustable radius from the destination.

10. A method for reducing battery consumption of a mobile terminal, the method comprising:
calculating a current location of the mobile terminal, route information to each of at least one destination, and an alarm period for determining whether the mobile terminal is near each destination, or at a nearby region thereof, if the at least one destination is input;
deactivating a locating module before an alarm period corresponding to a destination has elapsed, determining whether a location of the mobile terminal is the destination or is at the nearby region thereof if the alarm period corresponding to the destination has elapsed, and notifying the user that the location of the mobile terminal is the destination or is at the nearby region thereof if the location of the mobile terminal is at the destination or at the nearby region thereof; and
re-calculating at least one of route information and an alarm period which corresponds to a destination that is not the destination previously selected from among the at least one destinations.

11. The method of claim 10, further comprising:
re-calculating at least one of the route information to the destination and the alarm period by applying a moving speed and a location of a new transportation means, if a transportation means for moving to the at least one destinations is changed.

12. The method of claim 10, further comprising:
re-calculating at least one of the current location of the mobile terminal, the route information to the destination, and the alarm period by activating the locating module, if the alarm period has elapsed.

13. The method of claim 10, wherein one or more steps are repeated until the mobile terminal arrives at the destination or at the nearby region of the destination.

14. The method of claim 10, wherein the alarm period is a sum of a current time and a minimum time for which the locating module is deactivated.

15. The method of claim 14, wherein the minimum time is determined using a quotient of a distance between the current location and the destination divided by a moving speed of the mobile terminal.

16. The method of claim 10, further comprising:
updating route information and alarm periods corresponding to the other destinations except for the destination selected from among the at least one destinations by using the route information and the alarm period corresponding to the destination.

17. An apparatus for reducing battery consumption of a mobile terminal, the apparatus comprising:
a display unit;
a locating module; and
a controller configured to calculate a current location of the mobile terminal, route information to a destination, and an alarm period for determining whether the mobile terminal arrives at the destination or at a nearby region of the destination, if the destination is input into the display unit, to deactivate the locating module before the alarm period has elapsed, to determine whether the mobile terminal has arrived at the destination or the nearby region of the destination if the alarm period has elapsed, and to notify the user whether the mobile terminal has arrived at the destination or the nearby region of the destination.

18. The apparatus of claim 17, wherein if a transportation means for moving to the destination is changed, the controller re-calculates at least one of the route information to the destination and the alarm period by applying at least one of a moving speed and a location of a new transportation means.

19. The apparatus of claim 17, wherein if the alarm period has elapsed, the controller re-calculates at least one of the current location of the mobile terminal, the route information to the destination, and the alarm period by activating the locating module.

20. The apparatus of claim 17, wherein the controller repeatedly calculates at least one of the route information to the destination and the alarm period until the mobile terminal arrives at the destination.

21. The apparatus of claim 17, wherein the alarm period is a sum of a current time and a minimum time for which the locating module is deactivated.

22. The apparatus of claim 20, wherein the minimum time is determined using a quotient of a distance between the current location and the destination divided by a moving speed of the mobile terminal.

23. The apparatus of claim 18, wherein the transportation means is identified using at least one of a posture, a movement, a direction, a moving speed, a route, a signal strength, an ambient noise, a moving speed regularity, and a moving speed irregularity of the mobile terminal.

24. A computer-readable recording medium having recorded thereon a program comprising a command that, when executed, reduces battery consumption of a mobile terminal, the computer-readable recording medium comprising:
a first command configured to calculate a current location of the mobile terminal, route information to a destination, and an alarm period for determining whether the mobile terminal arrives at the destination or a nearby region of the destination, if the destination is input; and
a second command configured to deactivate a locating module before the alarm period has elapsed, to determine whether the mobile terminal arrives at the nearby region of the destination if the alarm period has elapsed, and to notify the user whether the mobile terminal arrives at the nearby region of the destination.

25. The computer-readable recording medium of claim 24, further comprising:
a third command set configured to re-calculate at least one of the route information to the destination and the alarm period by applying at least one of a moving speed and a location of a new transportation means, if a transportation means for moving to the destination is changed.

26. The computer-readable recording medium of claim 24, further comprising:
a fourth command set configured to re-calculate at least one of the current location of the mobile terminal, the route information to the destination, and the alarm period by activating the locating module, if the alarm period has elapsed.
